(19) United States
(12) Patent Application Publication
(10) Pub. No.: US 2016/0368426 A1
(43) Pub. Date: Dec. 22, 2016

(54) EXPANDABLE ROOF-TOP CARRIER

(71) Applicant: Jack Fugett, Mokena, IL (US)

(72) Inventor: Jack Fugett, Mokena, IL (US)

(21) Appl. No.: 14/741,551

(22) Filed: Jun. 17, 2015

(51) Int. Cl. B60R 9/045; B60R 9/055

(52) U.S. Cl. CPC B60R 9/045; B60R 9/055

(57) ABSTRACT

A roof-top carrier includes a support base adapted to coupled with a roof of a vehicle and an expandable lid including an upper shell, and an expander coupled between the rim and the upper shell. A storage volume may be defined between the expandable lid and the support base and the expander may be configured to provide means for allowing movement of the upper shell relative to the rim between a collapsed-profile position where the storage volume has a first size and an expanded-use position where the storage volume has a larger second size.

### BACKGROUND

The present disclosure relates to storage containers for vehicles, and particularly to roof-top carriers. More particularly, the present disclosure relates to expandable roof-top carriers.

### SUMMARY

A roof-top carrier in accordance with one aspect of the present disclosure includes a support base adapted to couple with a roof of a vehicle and an expandable lid including an upper shell, a rim, and an expander coupled between the rim and the upper shell. A storage volume may be defined between the expandable lid and the support base and the expander may be configured to provide means for allowing movement of the upper shell relative to the rim between a collapsed-profile position where the storage volume has a first size and an expanded-use position where the storage volume has a larger second size.

In illustrative embodiments, the expander may include a plurality of pleated sections coupled together to define seams.

In illustrative embodiments, the pleated sections may be folded toward one another about the seams in the collapsed-profile position and folded away from one another about the seams in the expanded-use position.

In illustrative embodiments, the expander may be formed of silicone, a rubber material, a thermoplastic elastomer, a fabric material, or combinations thereof

In illustrative embodiments, the expandable lid may be configured to pivot relative to the support base between an open position to allow access to the storage volume and a closed position to block access to the storage volume.

In illustrative embodiments, the roof-top carrier may further include a latch assembly coupled to the support base and configured to block pivoting movement of the expandable lid relative to the support base from the closed position to the open position.

In illustrative embodiments, the expander may include a plurality of flexible panels coupled together by a plurality of stiffening ribs.

In illustrative embodiments, the stiffening ribs may be spaced apart from one another in the expanded-use position and the flexible panels may be configured to bend to allow the stiffening ribs to move toward one another in the collapsed-profile position.

In illustrative embodiments, the stiffening ribs may be positioned in substantially the same plane in the collapsed-profile position.

In illustrative embodiments, the expander may be formed from silicone, a rubber material, a thermoplastic elastomer, a fabric material, or combinations thereof

In illustrative embodiments, the stiffening ribs may be thicker than the flexible panels.

In illustrative embodiments, the flexible panels may be formed from a first material and the stiffening ribs are formed from a less flexible second material.

In illustrative embodiments, the expandable lid may be configured to pivot relative to the support base between an open position to allow access to the storage volume and a closed position to block access to the storage volume.

In illustrative embodiments, the roof-top carrier may further include a latch assembly coupled to the support base, wherein the latch assembly may be configured to block pivoting movement of the expandable lid relative to the support base from the closed position to the open position.

In illustrative embodiments, the upper shell may be positioned to lie substantially below a plane defined by the rim in the collapsed-profile position and wherein the upper shell is spaced apart from the rim in the expanded-use position.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a top, side, and front perspective view of an expandable roof-top carrier in accordance with the present disclosure, wherein that the roof-top carrier includes a support base coupled to a rack of a vehicle roof for transportation of the roof-top carrier and an expandable lid coupled to the base to surround and accommodate articles of varying sizes positioned within the roof-top carrier;

FIG. 2 is a side elevation view of the roof-top carrier of FIG. 1 showing that the expandable lid includes a rim, an upper shell, and a bellows coupled between the rim and upper shell and depicting the expandable lid in an expanded-use position to provide a storage volume for storing articles within the roof-top carrier;

FIG. 3 is a view similar to FIG. 2 showing the expandable lid removed from the base, wherein the base includes a lower shell and a latch assembly for locking the expandable lid in a closed position relative to the support base;

FIG. 4 is a front elevation view of the roof-top carrier of FIG. 1 showing an embodiment in which the expandable lid rotationally pivots relative to the support base to allow a user to access the storage volume within the roof-top carrier;

FIG. 5 is a side elevation view of another embodiment of a roof-top carrier showing that the expandable lid pivots forward relative to the support base to allow a user to access the storage volume within the roof-top carrier and suggesting that a linkage assists with opening and closing of the roof-top carrier;

FIG. 6 is a top plan view of the roof-top carrier of FIG. 1 showing that the upper shell is positioned within a footprint of the rim and that the bellows extend between the rim and upper shell;

FIG. 7 is a view similar to FIG. 2 suggesting that the expandable lid has moved from the expanded-use position to a collapsed-profile position to minimize aerodynamic drag for when articles are not being stored in the roof-top carrier;

FIG. 8 is a top, side, and front perspective view of another embodiment of an expandable roof-top carrier in accordance with the present disclosure, wherein the roof-top carrier includes a support base coupled to a rack of a vehicle roof for transportation of the roof-top carrier and an expandable lid coupled to the base to surround and accommodate articles of varying sizes positioned within the roof-top carrier;

FIG. 9 is a side elevation view of the roof-top carrier of FIG. 1 showing that the expandable lid includes a rim, an upper shell, and a pop-up membrane coupled between the rim and upper shell and depicting the expandable lid in an expanded-use position to provide a storage volume for storing articles within the roof-top carrier; and

FIG. 10 is a top plan view of the roof-top carrier of FIG. 8 showing that the upper shell is positioned within a footprint of the rim and that the pop-up membrane extends between the rim and upper shell.

### DETAILED DESCRIPTION

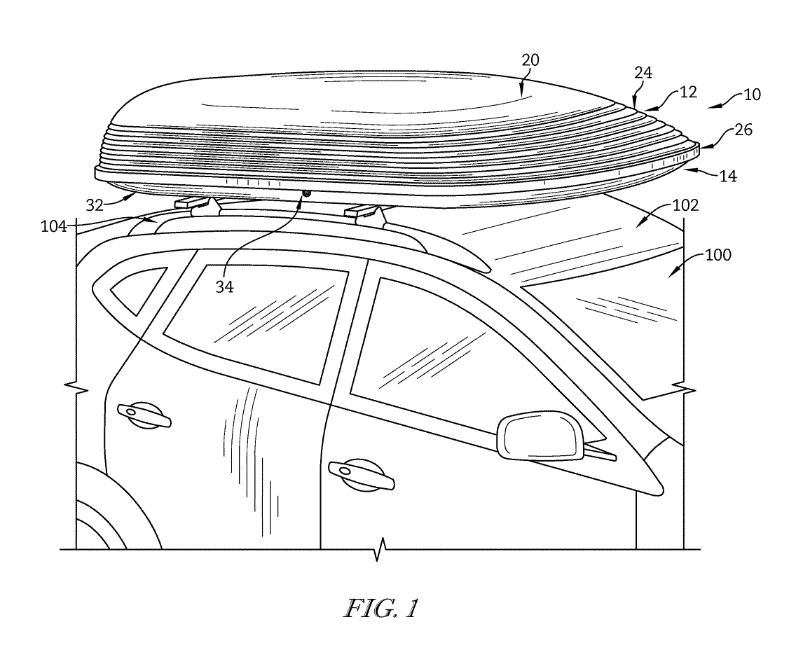

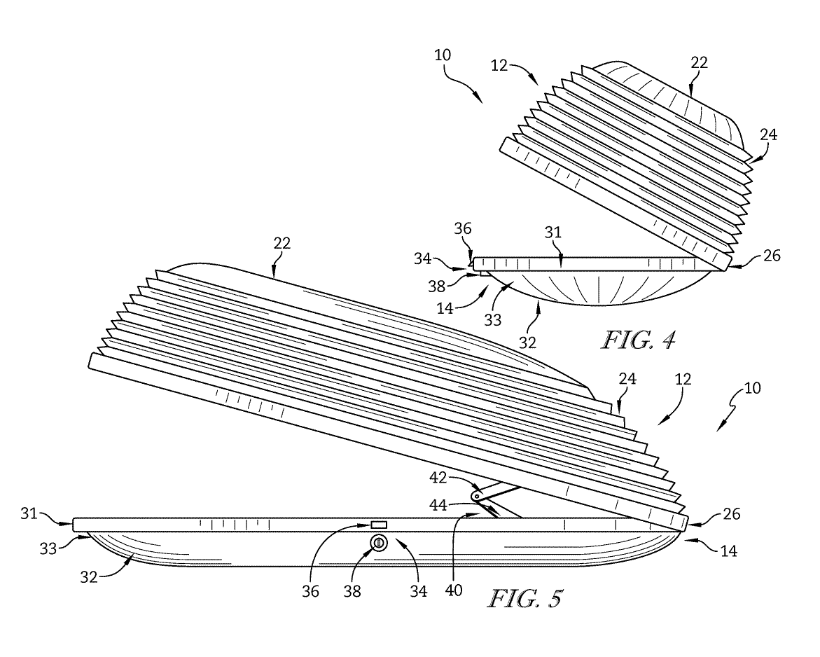

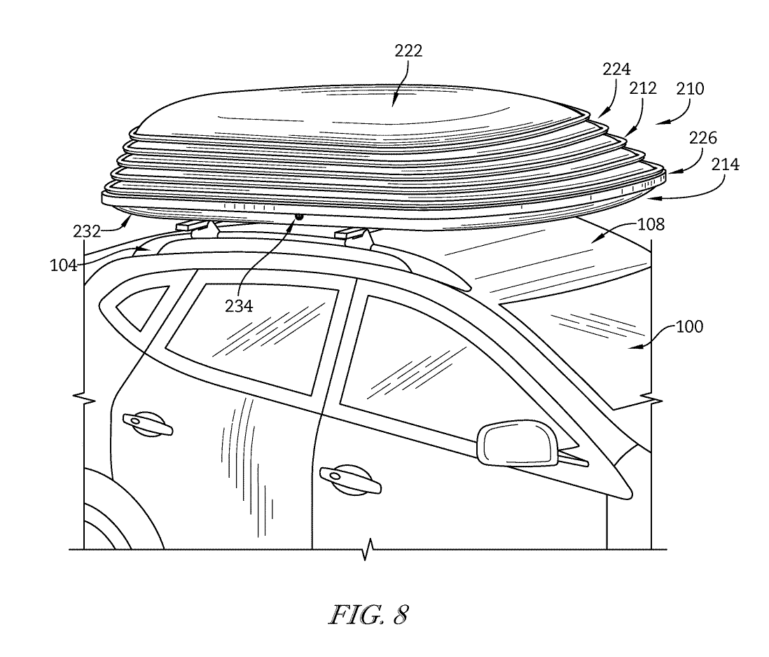

Roof-top carrier 10 includes a support base 14 and an expandable lid 12 that is coupled to support base 14 and movable between an expanded-use position, as suggested in FIG. 2, for storage of items within roof-top carrier 10 and a collapsed-profile position, as suggested in FIG. 7, for minimizing aerodynamic drag of roof-top carrier 10 when articles are not being stored therein. In illustrative embodiments, expandable lid 12 pivots relative to support base 14 between a closed position, as suggested in FIGS. 1 and 2, and an open position, as suggested in FIGS. 4 and 5.

An exemplary roof-top carrier 10 in accordance with the present disclosure is shown in FIG. 1. The roof-top carrier 10 includes a support base 14 and an expandable lid 12 coupled to the support base 14. The roof-top carrier 10 is configured to store items within a storage volume defined between the expandable lid 12 and the support base 14 and is further configured to be transported by a vehicle 100. The support base 14 is adapted to mate with a rack 104 attached to a roof 102 of the vehicle 100 in any suitable manner.

The expandable lid 12 includes an upper shell 22, a rim 26, and an expander 24 coupled between the upper shell 22 and the rim 26, as shown in FIG. 2. The upper shell 22 is substantially rigid and aerodynamically shaped to minimize drag. The rim 26 is substantially rigid and sized to surround the support base 14 to couple the expandable lid 12 with the support base 14. The support base 14 may include a lower shell 32 and a latch assembly 34 configured to engage with the expandable lid 12 to lock the expandable lid 12 in a closed position. In some embodiments, the upper shell 22, the rim 26, and the lower shell 32 are formed from a plastic and/or metallic material. However, other materials are possible such as carbon a metallic material, fiber, plastic, fiberglass, or combinations thereof, for example. Still further, any other suitable material or materials may be used. Additionally, one or more of the upper shell 22, the rim 26, and the lower shell 32 may be made of the same or different materials.

In the illustrative embodiment, the expander 24 comprises a bellows and includes a plurality of the pleated sections 21, 23 coupled together to define seams 25 where pleated sections 21, 23 fold relative to one another, as shown in FIG. 2. The expander 24 is flexible and allows the expandable lid 12 to move between an expanded-use position and a collapsed-storage position. More particularly, the expander 24 allows the expandable lid 12 to be moved toward and away from the support base 14 to effectively change a size or storage capacity of the roof-top carrier 10. In fact, one or more sets of pleated sections 21, 23 may be opened or expanded to vary a size and storage capacity of the roof-top carrier 10, thereby providing the roof-top carrier 10 with a variety of different sizes or storage capacities depending on the needs of a user.

In the expanded-use position, the pleated sections 21, 23 are folded away from one another to allow the upper shell 22 to extend away from the rim 26 and increase the storage volume within the roof-top carrier 10, as suggested in FIG. 2. In the collapsed-profile position, the pleated sections 21, 23 are folded toward one another at the seams 25 to allow the upper shell 22 to extend toward the rim 26 and decrease the storage volume within the roof-top carrier 10, as suggested in FIG. 7. In some embodiments, the expander 24 is formed from silicone. However, other suitable materials are possible, such as rubber materials, thermoplastic elastomers, fabric materials, or any suitable flexible materials, for example.

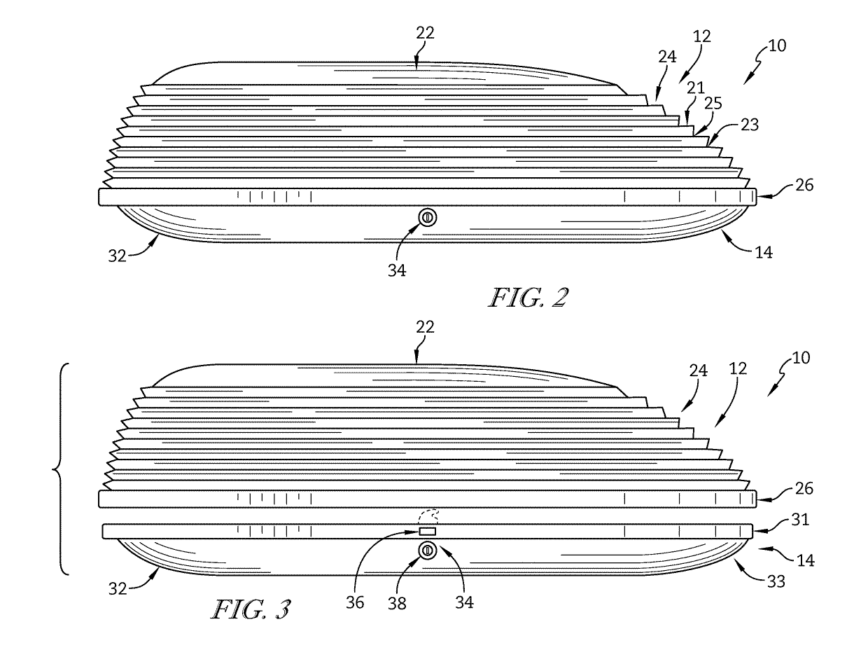

The lower shell 32 of the support base 14 is substantially rigid and may include a basin 33 and a lip 31 coupled to an upper perimeter edge of the basin 33, as shown in FIG. 3. The rim 26 of the expandable lid 12 is sized and shaped to surround the lip 31 to close the storage volume within the roof-top carrier 10. In an illustrative embodiment, the latch assembly 34 may include a lock 38 and a catch 36. The catch 36 engages with the rim 26 to maintain the expandable lid 12 in the closed position and the lock 38 engages with the catch 36 to prevent or allow opening of the roof-top carrier 10 at the selection of a user. In one embodiment, a hook 37, shown in phantom, is used in place of the catch 36. In other illustrative embodiments, any other suitable locking mechanism may be utilized to selectively couple the lip of the support base 14 and the rim 26 of the expandable lid 12.

In one illustrative embodiment, the expandable lid 12 may be configured to laterally pivot relative to the support base 14 to open the roof-top carrier 10 and allow access to the storage volume therein, as shown in FIG. 4. A hinge, for example, may be coupled between the rim 26 and the lip 31 along a first side of the roof-top carrier 10 to allow pivoting movement of the first side of the expandable lid 12. The latch assembly 34 is positioned on a second side of roof-top carrier 10 opposite the first side to engage with the rim 26 and allow opening of the expandable lid 12 at the selection of a user. In one embodiment, the hinge is positioned along a left side and the latch assembly 34 is positioned on a right side of roof-top carrier 10. In another embodiment, the hinge is positioned along the right side and the latch assembly 34 is positioned on a left side of the roof-top carrier 18.

In another illustrative embodiment, the expandable lid 12 may be configured to pivot forward relative to the support base 14 to open the roof-top carrier 10 and allow access to the storage volume therein, as shown in FIG. 5. A hinge, for example, may be coupled between the rim 26 and the lip 31 along a front side of the roof-top carrier 10 to allow pivoting movement of expandable lid 12. The latch assembly 34 may be positioned on a left side of the roof-top carrier 10 to engage with the rim 26 and allow opening of the expandable lid 12 at the selection of a user. Alternatively, the latch assembly 34 may be positioned on a right side or back side of the roof-top carrier 10. In one embodiment, the hinge is positioned along a back side of roof-top carrier 10 to allow rearward pivoting of expandable lid 12 and the latch assembly 34 may be positioned on the right, left, or front side of the roof-top carrier 10.

In the illustrative embodiment, a linkage 40 may be coupled between the expandable lid 12 and the support base 14 to assist a user with opening the roof-top carrier 10, as shown in FIG. 5. The linkage 40 may include a first linkage bar 42 coupled to the rim 26 and a second linkage bar 44 coupled to the lip 31. The linkage bars 42, 44 are coupled together for pivoting movement relative to one another and also pivoting relative to the rim 26 and the lip 31, respectively. The linkage bars 42, 44 are biased away from one another by a spring, for example, to provide an upward force against a weight of the expandable lid 12. A locking mechanism may also be utilized to lock the linkage bars 42, 44 in position, for example, during filling or emptying of the roof-top carrier 10. The locking mechanism may be unlocked to close the roof-top carrier.

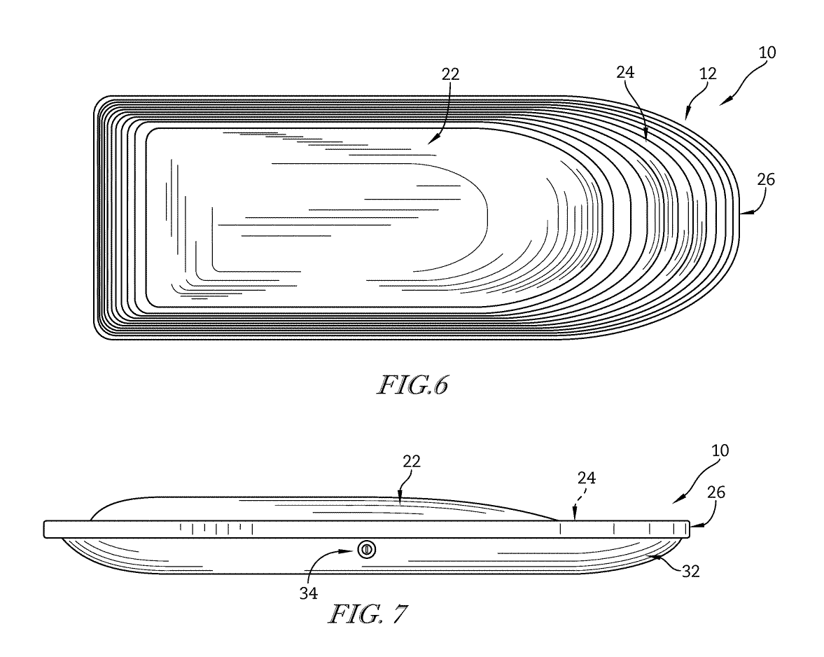

The upper shell 22 of the expandable lid 12 may have a smaller footprint than the rim 26 as suggested in FIG. 6. The expander 24 extends between the upper shell 22 and the rim 26 to fill a gap therebetween. In the collapsed-profile position, the expander 24 may lie completely or substantially below a plane defined by the rim 26 (within the lower shell 32), as suggested in FIG. 7. In other embodiments, both the expander and the upper shell 22 may lie completely or substantially below the plane defined by the rim 26. In other illustrative embodiments, a footprint (as seen from above in FIG. 6) of the upper shell 22 may be smaller than a footprint of the rim 26. In still other embodiments, the footprint of the upper shell 22 substantially matches a footprint of the rim 26.

Another roof-top carrier 210 in accordance with the present disclosure is shown in FIG. 8. The roof-top carrier 210 includes a support base 214 and an expandable lid 212 coupled to the support base 214. The roof-top carrier 210 is configured to store items within a storage volume defined between the expandable lid 212 and the support base 214 and be transported by the vehicle 100. The support base 214 is adapted to mate with the rack 104 attached to the roof 102 of the vehicle 100, in any suitable manner.

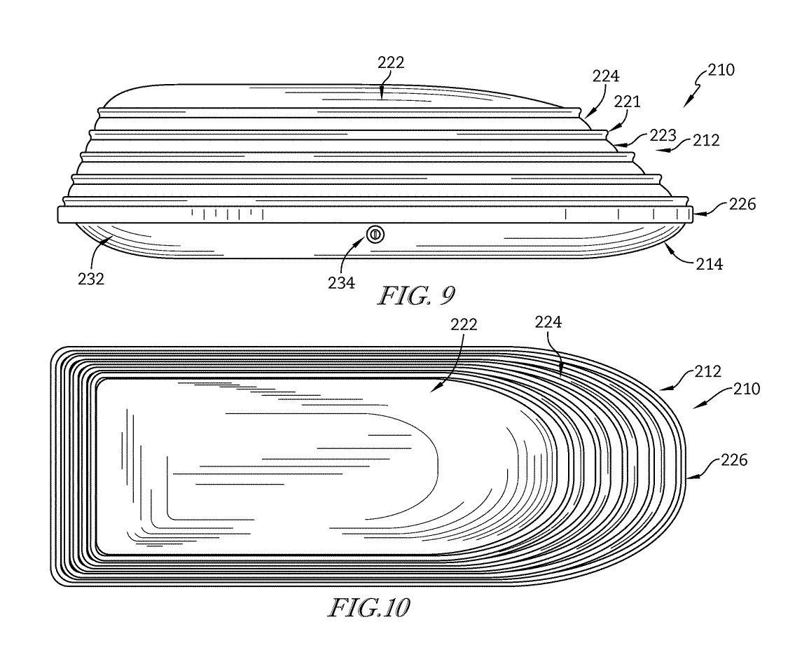

The expandable lid 212 includes an upper shell 222, a rim 226, and an expander 224 coupled between the upper shell 222 and the rim 226, as shown in FIG. 9. The upper shell 222 is substantially rigid and aerodynamically shaped to minimize drag. The rim 226 is substantially rigid and sized to surround the support base 214 to couple the expandable lid 212 with the support base 214. The support base 214 may include a lower shell 232 and a latch assembly 234 configured to engage with the expandable lid 212 to lock the expandable lid 212 in a closed position. In some embodiments, the upper shell 222, the rim 226, and the lower shell 232 are formed from a plastic and/or metallic material. However, other materials are possible such as carbon fiber or fiberglass, for example. Additionally, one or more of the upper shell 222, the rim 226, and the lower shell 232 may be made of the same or different materials.

In the illustrative embodiment, the expander 224 comprises a pop-up membrane that includes a plurality of flexible panels 223 coupled together by a plurality of stiffening ribs 221, as shown in FIG. 9. The expander 224 is flexible and allows the expandable lid 212 to move between an expanded-use position and a collapsed-storage position. In the expanded-use position, the ribs 221 are spaced apart from one another to allow the upper shell 222 to extend away from the rim 226, as suggested in FIG. 9. In the collapsed-profile position, the flexible panels 223 bend such that the ribs 221 move toward one another to allow the upper shell 222 to extend toward the rim 226, as suggested in FIG. 10. In some embodiments, the ribs 221 are in substantially the same plane when the expandable lid 212 is in the collapsed-profile position.

The ribs 221 may generally be stiffer or more rigid than the flexible panels 223. For example, the ribs 221 and the flexible panels 223 may be formed from the same material and the ribs 221 may be thicker than the flexible panels 223. In another example, the flexible panels 223 may be formed from a first material and the ribs 221 may be formed from a less flexible second material. In some embodiments, the expander 224 may be formed from silicone. However, other materials are possible, such as rubber materials, thermoplastic elastomers, fabric materials, or other flexible materials, or combinations thereof, for example.

The more rigid ribs 221 maintain the positioning of the panels 223 relative to one another at the selection of the user. In the expanded-use position, the ribs 221 are spaced apart from one another. In the collapsed-profile position, the ribs 221 are in substantially the same plane. Similar to the first embodiment, other intermediate positions are also possible depending on storage needs. More particularly, one or more of the rib 221/panel 223 combinations may be expanded to vary a size and storage capacity of the roof-top carrier 210.

The lower shell 232 of the support base 214 is substantially rigid and is similar in construction to the support base 14 of the first embodiment of FIGS. 1-8. The rim 226 of the expandable lid 212 is sized and shaped to surround an upper lip of the support base 214 to close the storage volume within the roof-top carrier 210. The expandable lid 212 is movable between an open position to allow access to the storage volume within the roof-top carrier 210 and a closed position blocking access to the storage volume. The latch assembly 234 may be similar in construction to latch assembly 34 of the first embodiment. The latch assembly 234 engages with the rim 226 to maintain the expandable lid 212 in the closed position and prevents or allows opening of the roof-top carrier 210 at the selection of a user.

In illustrative embodiments, the upper shell 222 of the expandable lid 212 may have a smaller footprint than the rim 226, as suggested in FIG. 10. In other illustrative embodiments, the footprint of the upper shell 222 substantially matches the footprint of the rim 226. While not described in detail, any one or more features or functions of the first embodiment of FIGS. 1-7 may be incorporated within the embodiment of FIGS. 8-10.

Regardless of the embodiment, the roof-top carriers 10, 210 discloses herein are designed to be expandable, such that a user only expands the roof-top carrier 10, 210 enough to hold the necessary items, thereby minimizing a size of the roof-top carrier 10, 210 and the overall aerodynamic drag caused by the roof-top carrier 10, 210. The overall shape of the roof-top carrier 10, 210 is also designed to reduce the amount of aerodynamic drag caused by the roof-top carrier 10, 210.

Any of the embodiments described herein may be modified to include any of the structures or methodologies disclosed in connection with other embodiments.

Further, although directional terminology, such as front, back, top, bottom, upper, lower, etc. may be used throughout the present specification, it should be understood that such terms are not limiting and are only utilized herein to convey the orientation of different elements with respect to one another.

1. A roof-top carrier for use with a vehicle, the roof-top carrier comprising
a support base adapted to couple with a roof of the vehicle, and
an expandable lid including an upper shell, a rim, and an expander coupled between the rim and the upper shell,
wherein a storage volume is defined between the expandable lid and the support base and the expander is configured to provide means for allowing movement of the upper shell relative to the rim between a collapsed-profile position where the storage volume has a first size and an expanded-use position where the storage volume has a larger second size.

2. The roof-top carrier of claim 1, wherein the expander includes a plurality of pleated sections coupled together to define seams.

3. The roof-top carrier of claim 2, wherein the pleated sections are folded toward one another about the seams in the collapsed-profile position and folded away from one another about the seams in the expanded-use position.

4. The roof-top carrier of claim 3, wherein the expander is formed from silicone, a rubber material, a thermoplastic elastomer, a fabric material, or combinations thereof.

5. The roof-top carrier of claim 3, wherein the expandable lid is configured to pivot relative to the support base between an open position to allow access to the storage volume and a closed position to block access to the storage volume.

6. The roof-top carrier of claim 5, further comprising a latch assembly coupled to the support base and configured to block pivoting movement of the expandable lid relative to the support base from the closed position to the open position.

7. The roof-top carrier of claim 1, wherein the expander includes a plurality of flexible panels coupled together by a plurality of stiffening ribs.

8. The roof-top carrier of claim 7, wherein the stiffening ribs are spaced apart from one another in the expanded-use position and wherein the flexible panels are configured to bend to allow the stiffening ribs to move toward one another in the collapsed-profile position.

9. The roof-top carrier of claim 8, wherein the stiffening ribs are positioned in substantially the same plane in the collapsed-profile position.

10. The roof-top carrier of claim 8, wherein the expander is formed from silicone, a rubber material, a thermoplastic elastomer, a fabric material, or combinations thereof.

11. The roof-top carrier of claim 10, wherein the stiffening ribs are thicker than the flexible panels.

12. The roof-top carrier of claim 8, wherein the flexible panels are formed from a first material and the stiffening ribs are formed from a less flexible second material.

13. The roof-top carrier of claim 8, wherein the expandable lid is configured to pivot relative to the support base between an open position to allow access to the storage volume and a closed position to block access to the storage volume.

14. The roof-top carrier of claim 13, further comprising a latch assembly coupled to the support base and configured to block pivoting movement of the expandable lid relative to the support base from the closed position to the open position.

15. The roof-top carrier of claim 1, wherein the upper shell is positioned to lie substantially below a plane defined by the rim in the collapsed-profile position and wherein the upper shell is spaced apart from the rim in the expanded-use position.
